(19) United States
(12) Patent Application Publication
(10) Pub. No.: US 2023/0029495 A1
(43) Pub. Date: Feb. 2, 2023

(54) OBJECT IDENTIFICATION AND TRACKING METHOD AND APPARATUS

(71) Applicant: BOE Technology Group Co., Ltd., Beijing (CN)

(72) Inventor: Jinglin YANG, Beijing (CN)

(21) Appl. No.: 17/789,397

(22) PCT Filed: Aug. 16, 2021
(86) PCT No.: PCT/CN2021/112670

§ 371 Date: Jun. 27, 2022

(30) Foreign Application Priority Data
Sep. 29, 2020 (CN) 202011050690.3

(51) Int. Cl. G06T 7/246; G06V 10/74; G06V 10/75

(52) U.S. Cl. CPC G06T 7/248; G06V 10/751; G06V 10/761; G06T 2207/10016

(57) ABSTRACT

The present disclosure provides an object identification and tracking method and an object identification and tracking apparatus. The object identification and tracking method includes: detecting M first objects in a target image; obtaining N second objects in tracking data in first video data, a matching weight of each second object with each first object varying with a time interval between a current image where the second object is located and the target image; matching the M first objects with the N second objects, so as to determine a correspondence between each first object and each second object; and tracking the first object in accordance with a matching result of the M first objects and the N second objects.

### CROSS-REFERENCE TO RELATED APPLICATION

This application claims a priority to the Chinese Patent Application No. 202011050690.3 filed on Sep. 29, 2020, which is incorporated herein by reference in its entirety.

### TECHNICAL FIELD

The present disclosure relates to the field of object tracking technology, in particular to an object identification and tracking method, and an object identification and tracking apparatus.

### BACKGROUND

In the process of video monitoring and video data processing, multi-target tracking is a common and practical technology. When carrying out the present disclosure, it is found that target tracking may be achieved through identifying targets and then accumulating multiple frames. However, this method requires a relatively large computational burden, and when the quantity of accumulated frames is relatively large, there is a relatively large calculation delay, resulting in a decrease in the tracking efficiency.

### SUMMARY

The present disclosure provides in a possible embodiment of the present disclosure an object identification and tracking method and an object identification and tracking apparatus, so as to improve the object identification and tracking efficiency.

In a first aspect, the present disclosure provides in a possible embodiment of the present disclosure an object identification and tracking method, including: detecting M first objects in a target image, M being a positive integer; obtaining N second objects in tracking data in first video data, the first video data including L images before the target image, N and L being both positive integers, and L being determined in accordance with a matching weight of each second object with each first object; matching the M first objects with the N second objects to determine a correspondence between each first object and each second object, the matching weight of each second object with the first object varying with a time interval between a current image where the second object is located and the target image; and tracking each first object in accordance with matching results of the M first objects and the N second objects.

In a possible embodiment of the present disclosure, the matching the M first objects with the N second objects to determine the correspondence between each first object and each second object includes: calculating feature distances between a feature vector of each of the N second objects in each of the L images and feature vectors of the M first objects; calculating a weighted movement average of the feature distances between each second object and the first objects in turn, the matching weights of each second object with the first objects increasing as the time interval between the current image where the second object is located and the target image decreases; and enabling the first object and the second object whose weighted movement average is greater than a predetermined threshold and is largest to correspond to each other.

In a possible embodiment of the present disclosure, the matching weights of the second objects with the first objects vary exponentially as the time intervals between the images where the second objects are located and the target image decrease.

In a possible embodiment of the present disclosure, the detecting the M first objects in the target image includes extracting feature vectors of the M first objects in the target image. The obtaining the N second objects in the tracking data in the first video data includes generating a feature vector corresponding to each tracked second object in the first video data. The matching the M first objects with the N second objects includes: calculating a feature distance between the feature vector of each first object and the feature vector of each second object; and determining a maximum match of the feature vector of each first object with the feature vectors of the N second objects in accordance with the feature distances, and taking the maximum match as the first object and the second object corresponding to each other.

In a possible embodiment of the present disclosure, the tracking the first objects in accordance with the matching results of the M first objects and the N second objects includes: when there is a first object matching a second object, tracking the first object and the second object as a same object; and when there is no first object matching a second object, adding a new tracking object in accordance with the second object.

In a second aspect, the present disclosure provides in some embodiments an object identification and tracking apparatus, including: a detection module configured to detect M first objects in a target image, M being a positive integer; a tracking data obtaining module configured to obtain N second objects in tracking data in first video data, the first video data including L images before the target image, N and L being both positive integers, and L being determined in accordance with a matching weight of each second object with each first object; a matching module configured to match the M first objects with the N second objects to determine a correspondence between each first object and each second object, the matching weight of each second object with the first object varying with a time interval between a current image where the second object is located and the target image; and a tracking module configured to track each first object in accordance with matching results of the M first objects and the N second objects.

In a possible embodiment of the present disclosure, the matching module includes: a distance calculation sub-module configured to calculate feature distances between a feature vector of each of the N second objects in each of the L images and feature vectors of the M first objects; a weighted movement average calculation sub-module configured to calculate a weighted movement average of the feature distances between each second object and the first objects in turn, the matching weights of each second object with the first objects increasing as the time interval between the current image where the second object is located and the target image decreases; and a matching sub-module configured to enable the first object and the second object whose weighted movement average is greater than a predetermined threshold and is largest to correspond to each other.

In a possible embodiment of the present disclosure, the matching weights of the second objects with the first objects vary exponentially as the time intervals between the images where the second objects are located and the target image decrease.

In a possible embodiment of the present disclosure, the detection module is specifically configured to extract feature vectors of the M first objects in the target image. The tracking data obtaining module is specifically configured to generate a feature vector corresponding to each tracked second object in the first video data. The distance calculation sub-module is specifically configured to calculate a feature distance between the feature vector of each first object and the feature vector of each second object, and the matching sub-module is specifically configured to determine a maximum match of the feature vector of each first object with the feature vectors of the N second objects in accordance with the feature distances, and take the maximum match as the first object and the second object corresponding to each other.

In a possible embodiment of the present disclosure, the tracking module is specifically configured to: when there is a first object matching a second object, track the first object and the second object as a same object; and when there is no first object matching a second object, add a new tracking object in accordance with the second object.

According to the embodiments of the present disclosure, the M first objects in the target image is detected, where M is a positive integer; the N second objects in tracking data in first video data is obtained, the first video data includes L images before the target image, N and L are both positive integers, and L is determined in accordance with the matching weight of each second object with each first object; the M first objects is matched with the N second objects to determine the correspondence between each first object and each second object, the matching weight of each second object with the first object varies with a time interval between the current image where the second object is located and the target image; and each first object is tracked in accordance with the matching results of the M first objects and the N second objects. As a result, it is able to determine the quantity of images used by the tracking data in accordance with the matching weight of the second object with the first object, so as to reduce the quantity of the to-be-used images in the first video data, thereby to improve the object identification and tracking efficiency.

### BRIEF DESCRIPTION OF THE DRAWINGS

In order to illustrate the technical solutions of the present disclosure in a clearer manner, the drawings desired for the present disclosure will be described hereinafter briefly. Obviously, the following drawings merely relate to some embodiments of the present disclosure, and based on these drawings, a person skilled in the art may obtain the other drawings without any creative effort.

FIG. 1 is a flow chart of an object identification and tracking method according to one embodiment of the present disclosure; and

FIG. 2 is a schematic view of an object identification and tracking apparatus according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

The present disclosure provides in some embodiments an object identification and tracking method.

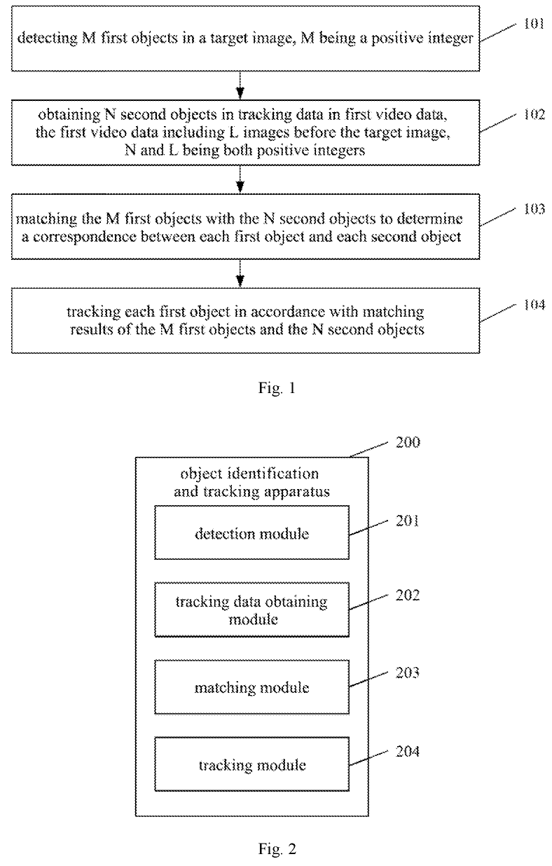

As shown in FIG. 1, in the embodiments of the present disclosure, the method includes the following steps.

Step 101: detecting M first objects in a target image, M being a positive integer.

In the embodiments of the present disclosure, the M first objects in the target image are detected at first. The first object may be a person or any other object.

In a possible embodiment of the present disclosure, Step 101 includes extracting feature vectors of the M first objects in the target image.

During the implementation, a detection box corresponding to each identified first object is established, and then a feature vector corresponding to the detection box is generated as the feature vector of the corresponding first object. During the implementation, the feature vector of each first object is extracted through a feature extraction algorithm including, but not limited to, deepsort.

Step 102: obtaining N second objects in tracking data in first video data, the first video data including L images before the target image, N and L being both positive integers.

The identification of the object is mainly performed with respect to the target image, while the tracking of the object is mainly performed through matching the images identified in historical video data with the objects in the target image. In this way, it is able to obtain such parameters as a movement trajectory and a movement speed of the object, so as to track the obj ect.

In the embodiments of the present disclosure, the first video data refers to the above-mentioned historical video data, and the target image refers to an image which is located after the first video data and in which the object has not been tracked continuously yet.

Further, in a possible embodiment of the present disclosure, Step 102 includes generating a feature vector corresponding to each tracked second object in the first video data.

Similar to Step 101, in the embodiments of the present disclosure, a tracking box corresponding to each tracked second object is established, and then a feature vector corresponding to each tracking box is generated.

It should be appreciated that, a format of the feature vector corresponding to the tracking box is the same as a format of the feature vector corresponding to the detection box. For example, when the feature vector corresponding to the detection box is a 128-dimensional feature vector, the feature vector corresponding to the tracking box is also a 128-dimensional feature vector.

Step 103: matching the M first objects with the N second objects to determine a correspondence between each first object and each second object.

After the M first objects in the target images and the N second objects in the tracking data have been determined, the first objects are matched with the second objects, so as to determine the correspondence between the first objects and the second objects.

During the implementation, each of the M first objects is matched with each of the N second objects. For example, a first one of the first objects is matched with first to N^{th} second objects in sequence to obtain N sets of matching data in total, a second one of the first objects is matched with the first to N^{th} second objects in sequence to obtain N sets of matching data, and so on, so as to obtain M*N sets of matching data in total, i.e., obtain the correspondence between each first object and each second object.

The matching weights of each second object with the first object vary with a time interval between a current image in which the second object is located and the target image. It should be appreciated that, the image where each second object is located is included in a plurality of images in the L images in the first video data. In order to obtain the tracking data about the second object, the data about each second object in the plurality of images in the L images is introduced.

On a time scale, different influence levels is caused by the data about each second object in different images on the data about the second object in the target frame, so in the embodiments of the present disclosure, the matching weight varying along with the time is further set, so as to improve a tracking effect of the second object.

In a possible embodiment of the present disclosure, Step 103 includes: calculating a feature distance between the feature vector of each first object and the feature vector of each second object; and determining a maximum match of the feature vector of each first object with the feature vectors of the N second objects in accordance with the feature distances, and taking the maximum match as the first object and the second object corresponding to each other.

In the embodiments of the present disclosure, the feature distances between the feature vectors of the first objects and the feature vectors of the second objects are calculated in accordance with a cosine distance or a Euclidean distance.

Taking the cosine distance as an example, dist =

$$1 - \frac{x ⋅ y}{\left‖x\right‖ ⋅ \left‖y\right‖} ,$$

where dist is the feature distance, and x and y are feature vectors of the first object and the second object respectively.

Further, after obtaining the feature distances between the feature vectors of the first objects and the feature vectors of the second objects, a Hungarian algorithm is used to determine the maximum match of the first objects with the second objects.

The maximum match of two sets refers to a situation where the objects in the two sets have most matching results. Hence, the calculating the maximum match of the set of first objects with the set of second objects actually refers to determining a one-to-one correspondence with the highest possibility between the first objects and the second objects, i.e., the maximum match may be considered as the one-to-one correspondence between the M first objects in the target images and the N second objects in the tracking data.

The Hungarian algorithm is used to find an augmenting path, and the augmenting path is used to find a maximum match of a bipartite graph.

The bipartite graph is defined as follows. When a node set V in a graph G is divided into two non-empty subsets V1 and V2 and two nodes m and n associated with any side m-n of the graph G belong to these two subsets respectively, G is just a bipartite graph.

The Hungarian algorithm includes the following basic steps.
Step 1: finding an object M capable of matching a current node m, when the object M has been matched, proceeding to Step 3, otherwise, proceeding to Step 2.
Step 2: marking a matching object of the object M as a current object m, and proceeding to Step 6.
Step 3: finding an object n with which the object M has matched, determining whether n is capable of matching any other object, if yes, proceeding to Step 4, otherwise, proceeding to Step 5.
Step 4: updating the matching object n to an object N, updating the matching object of the object M to aa, and proceeding to Step 6.
Step 5: finding a next object capable of matching the node m, and when it exists, proceeding to step 1, otherwise, proceeding to Step 6.
Step 6: returning to Step 1 with respect to a next node, until all the nodes have been traversed.

In the embodiments of the present disclosure, all the first objects belong to the set V1, all the second objects belong to the set V2. The first objects and the second objects are matched according to the feature distances between the feature vectors of the first objects and the feature vectors of the second objects.

Further, Step 103 specifically includes: calculating feature distances between a feature vector of each of the N second objects in each of the L images and feature vectors of the M first objects; calculating a weighted movement average of the feature distances between each second object and the first objects in turn, the matching weights of each second object with the first objects increasing as the time interval between the current image where the second object is located and the target image decreases; and enabling the first object and the second object whose weighted movement average is greater than a predetermined threshold and is largest to correspond to each other.

It should be appreciated that, for the L images in the first video data, the tracking of the second objects therein has been completed, so a position of each second object in the L images in the first video data may be understood as being already known.

Further, the feature distance between the feature vector of each second object and the feature vector of each first object in accordance with the feature vector of the second object in different images of the L images, and then the weighted movement average corresponding to each second object is calculated.

During the implementation, an order of the above steps may also be adjusted. For example, the weighted movement average of the feature vector of each second object is calculated, and then the feature distance between the weighted movement average of the feature vector of the second object and the feature vector of the first object is calculated.

During the implementation, the weighted movement average is calculated through vₜ = βvₜ₋₁ + (1-β)θₜ (1), where θₜ is a value to be calculated. Taking the calculation of the weighted movement average of the feature vector of a target second object as an example, θₜ represents the feature vector of the target second object at a time point t, especially in a t^{th} image in the L images. When different calculation methods are used, θₜ may also be a feature distance between the feature vector of the second object in the t^{th} image of the L images in the first video data and the feature vector of the first object, i.e., it may be determined in accordance with the selected calculation method.

A coefficient ^{β} represents a weighted lowering rate. The smaller the value of ^{β}, the larger the weighted lowering rate. ^{vₜ}represents a value of the weighted movement average at the time point t.

In a possible embodiment of the present disclosure, first objects A₁, A₂ are identified in the target image and second objects B₁, B₂, B₃ are included in the first video data. The first video data includes L images, and feature vectors of the second object B₂ in each image are denoted as B₁₁, B₁₂......, B_{1L-1}, and B_{1L}.

During the implementation, the feature distance between each first object and each second object is calculated. For example, a feature distance between the feature vector of the second object B₂ in a first image of the L images and a feature vector of the first object A₁ is denoted as A₁B₁₁. The feature distances A₁B₁₂, A₁B₁₃, ...... A₁B_{1L-1} and A₁B_{1L} may be calculated in a similar way.

Next, a weighted movement average of A₁B₁₁, A₁B₁₂, ...... A₁B_{1L-1} and A₁B_{1L} is calculated, i.e.,, A₁B₁₁, A₁B₁₂, ...... A₁B_{1L-1} and A₁B_{1L}, as θ₁, θ₂, ..., θ_{1L-1} and θ_{L}, are substituted into the above formula (1) so as to calculate the weighted movement average ^{vₜ}, and ^{Vₜ}is denoted as A₁B_{1X}. The matching weight of each second object with the first object increases as the time interval between the current image where the second object is located and the target image decreases, i.e., the matching weights of A₁B₁₁, A₁B₁₂, ...... A₁B_{1L-1} and A₁B_{1L} increase gradually.

In other words, for each image in the L images, the closer to the target image, the greater the association level between the image and the target image, and the greater the corresponding weighting weight.

In another possible embodiment of the present disclosure, after obtaining the feature vectors B₁₁, B₁₂......, B_{1L-1}, B_{1L} of the second object B2 in the L images as θ₁, θ₂......θ_{1L-1,} θ_{L}, the weighted movement average of these feature vectors, i.e., B₁ₓ, is calculated through the above-mentioned formula (1), and then the feature distance between B₁ₓ and feature vector of the first object A₁, i.e., A₁B_{1X}, is calculated.

In a possible embodiment of the present disclosure, the weighting weights vary exponentially as the time interval between the image where the second object is located and the target image decreases.

Further, the weighted movement average is calculated through vₜ =(1-β)(θₜ+βθₜ₋₁+···+β^{t-1}θ₁) (2). In this way, it is able to further reflect the influence level of the time on the object movement information, thereby to make full use of information in the image with a small time interval from the target image.

It should be appreciated that, L is determined in accordance with the matching weights of the second objects with the first objects.

During the implementation, a critical value may be set, e.g., ⅟e, where e is the natural base and approximately equal to 2.71828.... Further, in the embodiments of the present disclosure, a weighted lowering rate, i.e., β in the formula (2), set. For example, when β=0.9 , 0.9¹⁰ is approximately equal to ⅟e, so the weighted average relates to nearly 10 numerical values, and correspondingly, L is equal to 10. When β= 0.9⁵⁰ is approximately equal to ⅟e , so the weighted average relates to nearly 50 numerical values, and correspondingly, L is equal to 50.

In this way, the value of L is set in accordance with the matching weight of the second object with the first object, so it is able to select valid data, thereby to improve the object tracking effect. In addition, it is able to reduce the computational burden, thereby to improve the object tracking efficiency.

Step 104: tracking each first object in accordance with matching results of the M first objects and the N second objects.

Specifically, in a possible embodiment of the present disclosure, Step 104 includes: when there is a first object matching a second object, tracking the first object and the second object as a same object; and when there is no first object matching a second object, adding a new tracking object in accordance with the second object.

In the embodiments of the present disclosure, when there is a second object matching the first object, it means that the first object is very likely to be the same object as the second object. At this time, the second object and the first object are taken as the same object, so as to track the first objects. When there is no second object matching the first object, the first object probably does not appear in the video image previously. At this time, the first object is tracked as a new object. In this way, it is able to detect and track the objects in the video images continuously, thereby to monitor the objects in the corresponding region in the video images.

According to the embodiments of the present disclosure, it is able to determine the quantity of images used by the tracking data in accordance with the matching weight of the second object with the first object, so as to reduce the quantity of the to-be-used images in the first video data, thereby to improve the object identification and tracking efficiency.

The present disclosure further provides in some embodiments an object identification and tracking apparatus.

As shown in FIG. 1, in the embodiments of the present disclosure, the object identification and tracking apparatus 200 includes: a detection module 201 configured to detect M first objects in a target image, M being a positive integer; a tracking data obtaining module 202 configured to obtain N second objects in tracking data in first video data, the first video data including L images before the target image, N and L being both positive integers, and L being determined in accordance with a matching weight of each second object with each first object; a matching module 203 configured to match the M first objects with the N second objects to determine a correspondence between each first object and each second object, the matching weight of each second object with the first object varying with a time interval between a current image where the second object is located and the target image; and a tracking module 204 configured to track each first object in accordance with matching results of the M first objects and the N second objects.

In a possible embodiment of the present disclosure, the matching module 203 includes: a distance calculation sub-module configured to calculate feature distances between a feature vector of each of the N second objects in each of the L images and feature vectors of the M first objects; a weighted movement average calculation sub-module configured to calculate a weighted movement average of the feature distances between each second object and the first objects in turn, the matching weights of each second object with the first objects increasing as the time interval between the current image where the second object is located and the target image decreases; and a matching sub-module configured to enable the first object and the second object whose weighted movement average is greater than a predetermined threshold and is largest to correspond to each other.

In a possible embodiment of the present disclosure, the matching weights of the second objects with the first objects vary exponentially as the time intervals between the images where the second objects are located and the target image decrease.

In a possible embodiment of the present disclosure, the detection module 201 is specifically configured to extract feature vectors of the M first objects in the target image. The tracking data obtaining module is specifically configured to generate a feature vector corresponding to each tracked second object in the first video data. The distance calculation sub-module is specifically configured to calculate a feature distance between the feature vector of each first object and the feature vector of each second object, and the matching sub-module is specifically configured to determine a maximum match of the feature vector of each first object with the feature vectors of the N second objects in accordance with the feature distances, and take the maximum match as the first object and the second object corresponding to each other.

In a possible embodiment of the present disclosure, the tracking module is specifically configured to: when there is a first object matching a second object, track the first object and the second object as a same object; and when there is no first object matching a second object, add a new tracking object in accordance with the second object.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. An object identification and tracking method, comprising:
detecting M first objects in a target image, M being a positive integer;
obtaining N second objects in tracking data in first video data, the first video data comprising L images before the target image, N and L being both positive integers, and L being determined in accordance with a matching weight of each second object with each first object;
matching the M first objects with the N second objects to determine a correspondence between each first object and each second object, the matching weight of each second object with the first object varying with a time interval between a current image where the second object is located and the target image; and
tracking each first object in accordance with matching results of the M first objects and the N second objects.

2. The object identification and tracking method according to claim 1, wherein the matching the M first objects with the N second objects to determine the correspondence between each first object and each second object comprises: calculating feature distances between a feature vector of each of the N second objects in each of the L images and feature vectors of the M first objects; calculating a weighted movement average of the feature distances between each second object and the first objects in turn, the matching weights of each second object with the first objects increasing as the time interval between the current image where the second object is located and the target image decreases; and enabling the first object and the second object whose weighted movement average is greater than a predetermined threshold and is largest to correspond to each other.

3. The object identification and tracking method according to claim 1, wherein the matching weights of the second objects with the first objects vary exponentially as the time intervals between the images where the second objects are located and the target image decrease.

4. The object identification and tracking method according to claim 1, wherein the detecting the M first objects in the target image comprises extracting feature vectors of the M first objects in the target image, wherein the obtaining the N second objects in the tracking data in the first video data comprises generating a feature vector corresponding to each tracked second object in the first video data, wherein the matching the M first objects with the N second objects comprises: calculating a feature distance between the feature vector of each first object and the feature vector of each second object; and determining a maximum match of the feature vector of each first object with the feature vectors of the N second objects in accordance with the feature distances, and taking the maximum match as the first object and the second object corresponding to each other.

5. The object identification and tracking method according to claim 1, wherein the tracking the first objects in accordance with the matching results of the M first objects and the N second objects comprises: when there is a first object matching a second object, tracking the first object and the second object as a same object; and when there is no first object matching a second object, adding a new tracking object in accordance with the second object.

6. An electronic apparatus, comprising a processor, a memory, and a program stored in the memory and executed by the processor, wherein the processor is configured to execute the program, so as to:
detect M first objects in a target image, M being a positive integer;
obtain N second objects in tracking data in first video data, the first video data comprising L images before the target image, N and L being both positive integers, and L being determined in accordance with a matching weight of each second object with each first object;
match the M first objects with the N second objects to determine a correspondence between each first object and each second object, the matching weight of each second object with the first object varying with a time interval between a current image where the second object is located and the target image; and
track each first object in accordance with matching results of the M first objects and the N second objects.

7. The electronic apparatus according to claim 6, wherein the processor is further configured to execute the program, so as to: calculate feature distances between a feature vector of each of the N second objects in each of the L images and feature vectors of the M first objects; calculate a weighted movement average of the feature distances between each second object and the first objects in turn, the matching weights of each second object with the first objects increasing as the time interval between the current image where the second object is located and the target image decreases; and enable the first object and the second object whose weighted movement average is greater than a predetermined threshold and is largest to correspond to each other.

8. The electronic apparatus according to claim 7, wherein the matching weights of the second objects with the first objects vary exponentially as the time intervals between the images where the second objects are located and the target image decrease.

9. The electronic apparatus according to claim 7, wherein the processor is further configured to execute the program, so as to: extract feature vectors of the M first objects in the target image; generate a feature vector corresponding to each tracked second object in the first video data; calculate a feature distance between the feature vector of each first object and the feature vector of each second object; and determine a maximum match of the feature vector of each first object with the feature vectors of the N second objects in accordance with the feature distances, and take the maximum match as the first object and the second object corresponding to each other.

10. The electronic apparatus according to claim 6, wherein the processor is further configured to execute the program, so as to: when there is a first object matching a second object, track the first object and the second object as a same object; and when there is no first object matching a second object, add a new tracking object in accordance with the second object.

11. The object identification and tracking method according to claim 2, wherein the detecting the M first objects in the target image comprises extracting feature vectors of the M first objects in the target image, wherein the obtaining the N second objects in the tracking data in the first video data comprises generating a feature vector corresponding to each tracked second object in the first video data, wherein the matching the M first objects with the N second objects comprises: calculating a feature distance between the feature vector of each first object and the feature vector of each second object; and determining a maximum match of the feature vector of each first object with the feature vectors of the N second objects in accordance with the feature distances, and taking the maximum match as the first object and the second object corresponding to each other.

12. A non-transitory computer-readable storage medium storing therein a program, wherein the program is executed by the processor, so as to:
detect M first objects in a target image, M being a positive integer;
obtain N second objects in tracking data in first video data, the first video data comprising L images before the target image, N and L being both positive integers, and L being determined in accordance with a matching weight of each second object with each first object;
match the M first objects with the N second objects to determine a correspondence between each first object and each second object, the matching weight of each second object with the first object varying with a time interval between a current image where the second object is located and the target image; and
track each first object in accordance with matching results of the M first objects and the N second objects.

13. The non-transitory computer-readable storage medium according to claim 12, wherein the program is further executed by the processor, so as to: calculate feature distances between a feature vector of each of the N second objects in each of the L images and feature vectors of the M first objects; calculate a weighted movement average of the feature distances between each second object and the first objects in turn, the matching weights of each second object with the first objects increasing as the time interval between the current image where the second object is located and the target image decreases; and enable the first object and the second object whose weighted movement average is greater than a predetermined threshold and is largest to correspond to each other.

14. The non-transitory computer-readable storage medium according to claim 13, wherein the matching weights of the second objects with the first objects vary exponentially as the time intervals between the images where the second objects are located and the target image decrease.

15. The non-transitory computer-readable storage medium according to claim 13, wherein the program is further executed by the processor, so as to: extract feature vectors of the M first objects in the target image; generate a feature vector corresponding to each tracked second object in the first video data; calculate a feature distance between the feature vector of each first object and the feature vector of each second object; and determine a maximum match of the feature vector of each first object with the feature vectors of the N second objects in accordance with the feature distances, and take the maximum match as the first object and the second object corresponding to each other.

16. The non-transitory computer-readable storage medium according to claim 12, wherein the program is further executed by the processor, so as to: when there is a first object matching a second object, track the first object and the second object as a same object; and when there is no first object matching a second object, add a new tracking object in accordance with the second object.
